(19) United States
(12) Patent Application Publication
(10) Pub. No.: US 2024/0015613 A1
(43) Pub. Date: Jan. 11, 2024

(54) TECHNIQUES FOR INDICATING A FREQUENCY BAND DURING BLIND HANDOVER

(71) Applicant: QUALCOMM Incorporated, San Diego, CA (US)

(72) Inventor: Peng CHENG, Beijing (CN)

(21) Appl. No.: 18/040,557

(22) PCT Filed: Oct. 8, 2020
(86) PCT No.: PCT/CN2020/119870

§ 371 Date: Feb. 3, 2023

(51) Int. Cl. H04W 36/00; H04W 36/38

(52) U.S. Cl. CPC H04W 36/0072; H04W 36/38

(57) ABSTRACT

Various aspects of the present disclosure generally relate to wireless communication. In some aspects, a user equipment (UE) may receive a configuration message associated with a blind handover, wherein the configuration message indicates a frequency band for a target cell. The UE may measure a synchronization signal, from the target cell, based at least in part on the configuration message. Numerous other aspects are provided.

### FIELD OF THE DISCLOSURE

Aspects of the present disclosure generally relate to wireless communication and to techniques and apparatuses for indicating a frequency band during blind handover.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving a configuration message associated with a blind handover, wherein the configuration message indicates a frequency band for a target cell; and measuring a synchronization signal, from the target cell, based at least in part on the configuration message.

In some aspects, the configuration message further indicates an absolute radio-frequency channel number (ARFCN) for the target cell.

In some aspects, the configuration message includes a radio resource control (RRC) reconfiguration message.

In some aspects, the synchronization signal includes a synchronization signal block (SSB).

In some aspects, the configuration message further indicates at least one of a subcarrier spacing (SCS) or a measurement timing configuration for the synchronization signal.

In some aspects, the configuration message is received from a master node.

In some aspects, the target cell is within a New Radio (NR) network, and the master node is within a legacy network.

In some aspects, the configuration message is received from a secondary node.

In some aspects, the secondary node is within a New Radio (NR) network, and the target cell is a secondary cell.

In some aspects, the configuration message is received from a cell within a standalone (SA) New Radio (NR) network.

In some aspects, the target cell is within a different NR network.

In some aspects, the target cell is a secondary cell.

In some aspects, measuring the synchronization signal comprises applying a receive filter, based at least in part on the frequency band, to measure the synchronization signal.

In some aspects, a method of wireless communication performed by a base station includes determining that a frequency band for a target cell overlaps with at least one other frequency band; and transmitting, to a UE and based at least in part on the determination, a configuration message associated with a blind handover, wherein the configuration message indicates the frequency band for the target cell.

In some aspects, the configuration message further indicates an ARFCN for the target cell.

In some aspects, the configuration message includes an RRC reconfiguration message.

In some aspects, the configuration message triggers the UE to measure a synchronization signal.

In some aspects, the synchronization signal includes an SSB.

In some aspects, the configuration message further indicates at least one of an SCS or a measurement timing configuration for the synchronization signal.

In some aspects, the base station is a master node.

In some aspects, the target cell is within an NR network, and the master node is within a legacy network.

In some aspects, the base station is a secondary node.

In some aspects, the secondary node is within an NR network, and the target cell is a secondary cell.

In some aspects, the base station is included in a cell within an SA NR network.

In some aspects, the target cell is within a different NR network.

In some aspects, the target cell is a secondary cell.

In some aspects, a UE for wireless communication includes a memory and one or more processors operatively coupled to the memory, the memory and the one or more processors configured to receive a configuration message associated with a blind handover, wherein the configuration message indicates a frequency band for a target cell; and measure a synchronization signal, from the target cell, based at least in part on the configuration message.

In some aspects, the configuration message further indicates an ARFCN for the target cell.

In some aspects, the configuration message includes an RRC reconfiguration message.

In some aspects, the synchronization signal includes an SSB.

In some aspects, the configuration message further indicates at least one of an SCS or a measurement timing configuration for the synchronization signal.

In some aspects, the configuration message is received from a master node.

In some aspects, the target cell is within an NR network, and the master node is within a legacy network.

In some aspects, the configuration message is received from a secondary node.

In some aspects, the secondary node is within an NR network, and the target cell is a secondary cell.

In some aspects, the configuration message is received from a cell within an SA NR network.

In some aspects, the target cell is within a different NR network.

In some aspects, the target cell is a secondary cell.

In some aspects, the one or more processors, when measuring the synchronization signal, are configured to apply a receive filter, based at least in part on the frequency band, to measure the synchronization signal.

In some aspects, a base station for wireless communication includes a memory and one or more processors operatively coupled to the memory, the memory and the one or more processors configured to determine that a frequency band for a target cell overlaps with at least one other frequency band; and transmit, to a UE and based at least in part on the determination, a configuration message associated with a blind handover, wherein the configuration message indicates the frequency band for the target cell.

In some aspects, the configuration message further indicates an ARFCN for the target cell.

In some aspects, the configuration message includes an RRC reconfiguration message.

In some aspects, the configuration message triggers the UE to measure a synchronization signal.

In some aspects, the synchronization signal includes an SSB.

In some aspects, the configuration message further indicates at least one of an SCS or a measurement timing configuration for the synchronization signal.

In some aspects, the base station is a master node.

In some aspects, the target cell is within an NR network, and the master node is within a legacy network.

In some aspects, the base station is a secondary node.

In some aspects, the secondary node is within an NR network, and the target cell is a secondary cell.

In some aspects, the base station is included in a cell within an SA NR network.

In some aspects, the target cell is within a different NR network.

In some aspects, the target cell is a secondary cell.

In some aspects, a non-transitory computer-readable medium storing a set of instructions for wireless communication includes one or more instructions that, when executed by one or more processors of a UE, cause the UE to receive a configuration message associated with a blind handover, wherein the configuration message indicates a frequency band for a target cell; and measure a synchronization signal, from the target cell, based at least in part on the configuration message.

In some aspects, the configuration message further indicates an ARFCN for the target cell.

In some aspects, the configuration message includes an RRC reconfiguration message.

In some aspects, the synchronization signal includes an SSB.

In some aspects, the configuration message further indicates at least one of an SCS or a measurement timing configuration for the synchronization signal.

In some aspects, the configuration message is received from a master node.

In some aspects, the target cell is within an NR network, and the master node is within a legacy network.

In some aspects, the configuration message is received from a secondary node.

In some aspects, the secondary node is within an NR network, and the target cell is a secondary cell.

In some aspects, the configuration message is received from a cell within an SA NR network.

In some aspects, the target cell is within a different NR network.

In some aspects, the target cell is a secondary cell.

In some aspects, the one or more instructions, that cause the UE to measure the synchronization signal, cause the UE to apply a receive filter, based at least in part on the frequency band, to measure the synchronization signal.

In some aspects, a non-transitory computer-readable medium storing a set of instructions for wireless communication includes one or more instructions that, when executed by one or more processors of a base station, cause the base station to determine that a frequency band for a target cell overlaps with at least one other frequency band; and transmit, to a UE and based at least in part on the determination, a configuration message associated with a blind handover, wherein the configuration message indicates the frequency band for the target cell.

In some aspects, the configuration message further indicates an ARFCN for the target cell.

In some aspects, the configuration message includes an RRC reconfiguration message.

In some aspects, the configuration message triggers the UE to measure a synchronization signal.

In some aspects, the synchronization signal includes an SSB.

In some aspects, the configuration message further indicates at least one of an SCS or a measurement timing configuration for the synchronization signal.

In some aspects, the base station is a master node.

In some aspects, the target cell is within an NR network, and the master node is within a legacy network.

In some aspects, the base station is a secondary node.

In some aspects, the secondary node is within an NR network, and the target cell is a secondary cell.

In some aspects, the base station is included in a cell within an SA NR network.

In some aspects, the target cell is within a different NR network.

In some aspects, the target cell is a secondary cell.

In some aspects, an apparatus for wireless communication includes means for receiving a configuration message associated with a blind handover, wherein the configuration message indicates a frequency band for a target cell; and means for measuring a synchronization signal, from the target cell, based at least in part on the configuration message.

In some aspects, the configuration message further indicates an ARFCN for the target cell.

In some aspects, the configuration message includes an RRC reconfiguration message.

In some aspects, the synchronization signal includes an SSB.

In some aspects, the configuration message further indicates at least one of an SCS or a measurement timing configuration for the synchronization signal.

In some aspects, the configuration message is received from a master node.

In some aspects, the target cell is within an NR network, and the master node is within a legacy network.

In some aspects, the configuration message is received from a secondary node.

In some aspects, the secondary node is within an NR network, and the target cell is a secondary cell.

In some aspects, the configuration message is received from a cell within an SA NR network.

In some aspects, the target cell is within a different NR network.

In some aspects, the target cell is a secondary cell.

In some aspects, the means for measuring the synchronization signal comprise means for applying a receive filter, based at least in part on the frequency band, to measure the synchronization signal.

In some aspects, an apparatus for wireless communication includes means for determining that a frequency band for a target cell overlaps with at least one other frequency band; and means for transmitting, to a UE and based at least in part on the determination, a configuration message associated with a blind handover, wherein the configuration message indicates the frequency band for the target cell.

In some aspects, the configuration message further indicates an ARFCN for the target cell.

In some aspects, the configuration message includes an RRC reconfiguration message.

In some aspects, the configuration message triggers the UE to measure a synchronization signal.

In some aspects, the synchronization signal includes an SSB.

In some aspects, the configuration message further indicates at least one of an SCS or a measurement timing configuration for the synchronization signal.

In some aspects, the apparatus is a master node.

In some aspects, the target cell is within an NR network, and the master node is within a legacy network.

In some aspects, the apparatus is a secondary node.

In some aspects, the secondary node is within an NR network, and the target cell is a secondary cell.

In some aspects, the apparatus is included in a cell within an SA NR network.

In some aspects, the target cell is within a different NR network.

In some aspects, the target cell is a secondary cell.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of blind handover, in accordance with various aspects of the present disclosure.

FIG. 4 is a diagram illustrating an example associated with indicating a frequency band during blind handover, in accordance with various aspects of the present disclosure.

FIGS. 5 and 6 are diagrams illustrating example processes associated with indicating a frequency band during blind handover, in accordance with various aspects of the present disclosure.

FIGS. 7 and 8 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

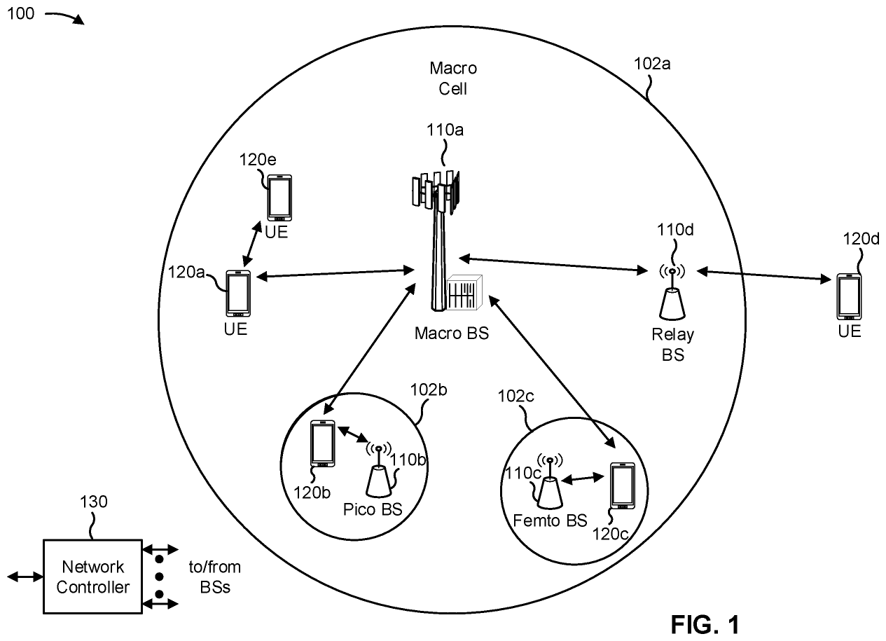

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

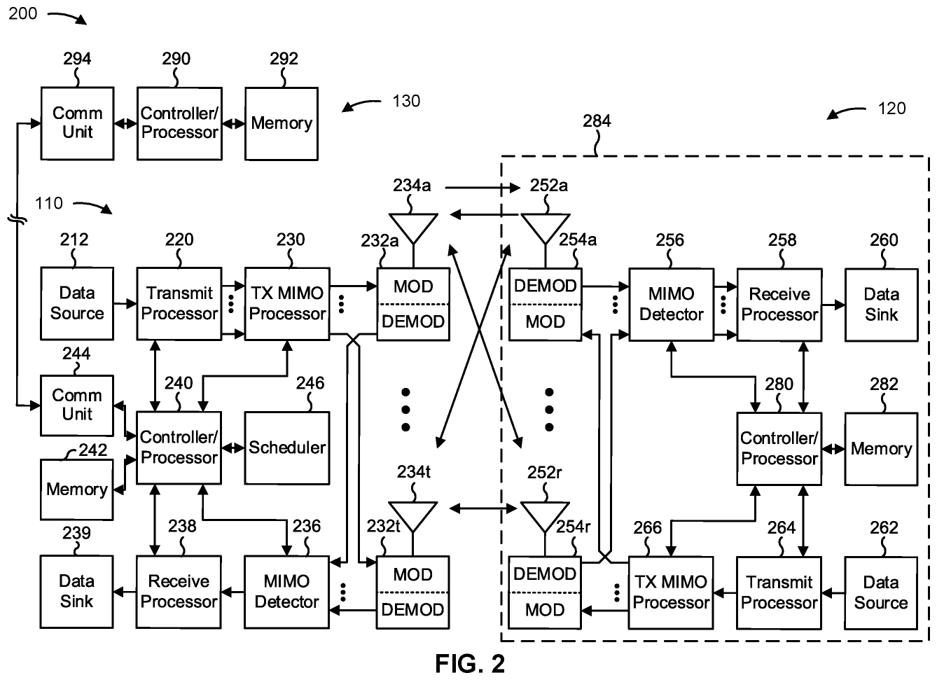

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MC S(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

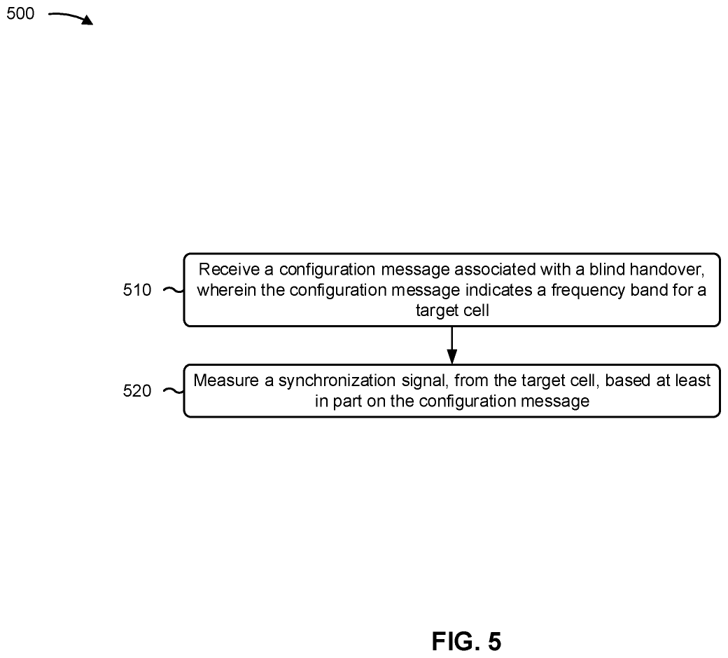

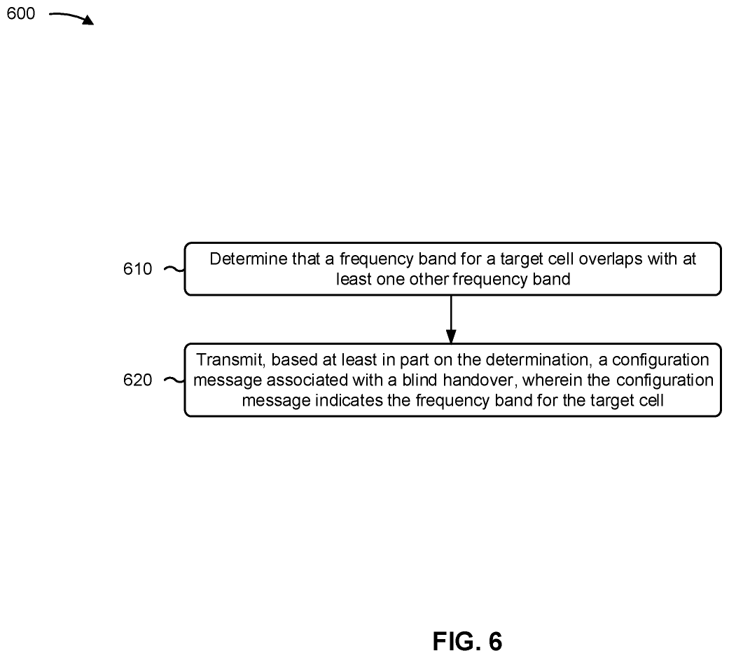

Controller/processor 240 of base station 110, controller/processor 280 of UE 120, and/or any other component(s) of FIG. 2 may perform one or more techniques associated with indicating a frequency band during blind handover, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, interpreting the instructions, and/or the like.

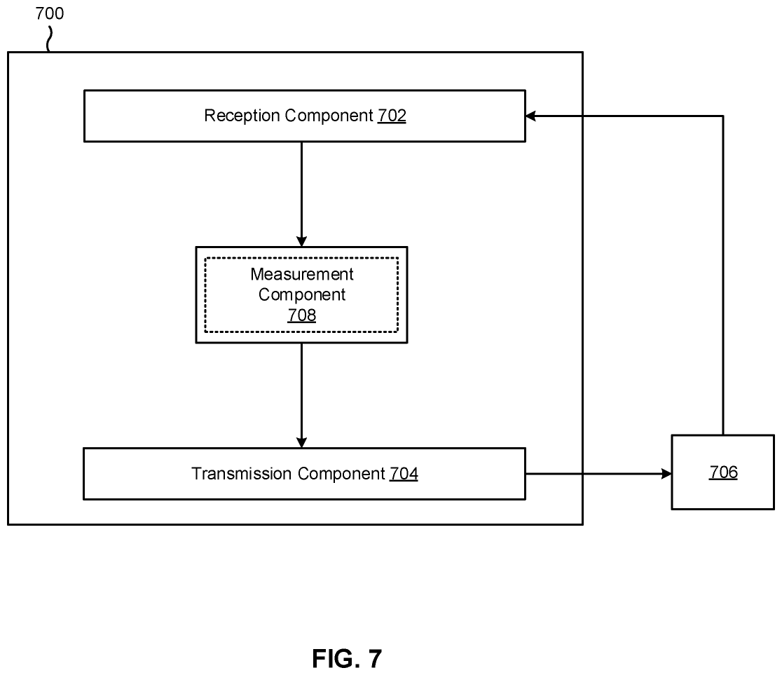

In some aspects, a UE (e.g., UE 120 and/or apparatus 700 of FIG. 7) may include means for receiving a configuration message associated with a blind handover, wherein the configuration message indicates a frequency band for a target cell; and/or means for measuring a synchronization signal, from the target cell, based at least in part on the configuration message. The means for the UE to perform operations described herein may include, for example, antenna 252, demodulator 254, MIMO detector 256, receive processor 258, transmit processor 264, TX MIMO processor 266, modulator 254, controller/processor 280, and/or memory 282.

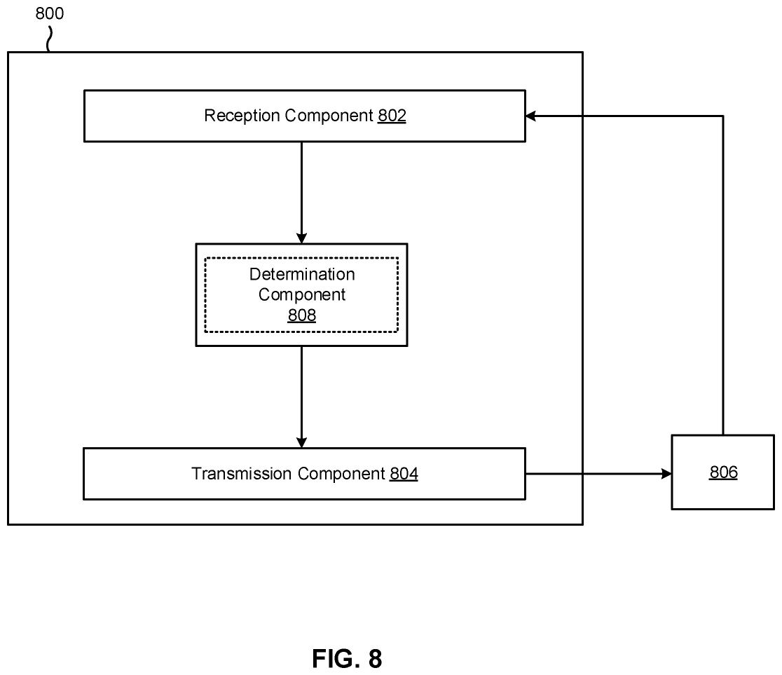

In some aspects, a base station (e.g., base station 110 and/or apparatus 800 of FIG. 8) may include means for determining that a frequency band for a target cell overlaps with at least one other frequency band; and/or means for transmitting, to a UE (e.g., UE 120 and/or apparatus 700 of FIG. 7) and based at least in part on the determination, a configuration message associated with a blind handover, wherein the configuration message indicates the frequency band for the target cell. The means for the base station to perform operations described herein may include, for example, transmit processor 220, TX MIMO processor 230, modulator 232, antenna 234, demodulator 232, MIMO detector 236, receive processor 238, controller/processor 240, memory 242, and/or scheduler 246.

As indicated above, FIG. 2 is provided as an example. Other examples may differ from what is described with regard to FIG. 2.

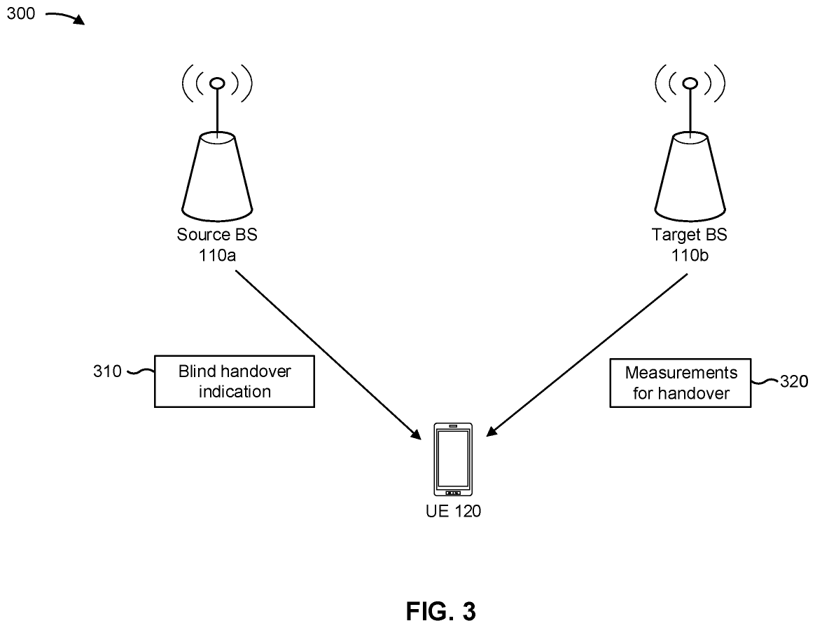

FIG. 3 is a diagram illustrating an example 300 of blind handover, in accordance with various aspects of the present disclosure. In example 300, a source base station 110a may initiate handover of a UE 120 to a target base station 110b. In some aspects, the source base station 110a and the target base station 110b may be associated with a same wireless network. For example, the source base station 110a may initiate handover of the UE 120 based at least in part on mobility of the UE 120 away from the source base station 110a and toward the target base station 110b. As an alternative, the source base station 110a and the target base station 110b may be associated with different wireless networks. For example, the source base station 110a may be associated with a legacy network (e.g., an LTE network), and the target base station 110b may be associated with an NR network to be added as a secondary cell group (SCG) with the legacy network (e.g., in an non-standalone (NSA) mode of operation). In another example, the source base station 110a may be associated with a legacy network (e.g., an LTE network), and the target base station 110b may be associated with an NR network to which the UE 120 is to connect (e.g., in a standalone (SA) mode of operation).

As shown in connection with reference number 310, the source base station 110a may transmit, and the UE 120 may receive, a configuration message associated with a blind handover. For example, the configuration message may include a radio resource control (RRC) message, such as an RRC Reconfiguration message (e.g., as defined in 3GPP specifications and/or another standard).

In some aspects, configuration message may be associated with a blind handover because the source base station 110a did not request that the UE 120 perform measurements (e.g., RSRP, CQI, and/or other measurements of signal strength) of one or more reference signals (e.g., a synchronization signal block (SSB), a tracking reference signal (TRS), and/or other reference signal), from the target base station 110b, before transmitting the configuration message. Accordingly, as shown in connection with reference number 320, the UE 120 may perform measurements after receiving the configuration message. For example, the UE 120 may measure one or more reference signals (e.g., an SSB, a TRS, and/or other reference signal) from the target base station 110b in order to initiate an RRC connection with the target base station 110b.

Generally, a configuration message associated with a blind handover includes an indicator of an absolute radio-frequency channel number (ARFCN). For example, an RRC reconfiguration message may include an ARFCN-ValueNR data element (e.g., as defined in 3GPP specifications). However, an indicator of a frequency band (e.g., a freqBandIndicatorNR data element and/or other similar data element) is generally included in a measurement request (e.g., a MeasObjectNR data structure as defined in 3GPP specifications and/or other similar data structure). Accordingly, a UE will not receive an indicator of a frequency band during the blind handover because a source base station will not have transmitted a measurement request in advance of initiating the handover.

The lack of a frequency band may cause the UE to search through more reception filters to find an optimal reception filter when measuring one or more reference signals from a target base station. For example, the UE may have to search through additional filters when the ARFCN overlaps multiple bands. Table 1 below shows some examples of these overlaps:

| Frequency | Uplink Frequency | Downlink Frequency | |
|---|---|---|---|
| Band | Range | Range | ARFCN |
| GSM 450 | 450.4 to 457.6 MHz | 460.4 to 467.6 MHz | 259 to 293 |
| GSM 480 | 478.8 to 486 MHz | 488.8 to 496 MHz | 306 to 340 |
| GSM 750 | 747 to 762 MHz | 777 to 792 MHz | 438 to 511 |
| GSM 850 | 824 to 849 MHz | 869 to 894 MHz | 128 to 251 |
| P-GSM 900 | 890 to 915 MHz | 935 to 960 MHz | 1 to 124 |
| E-GSM 900 | 880 to 915 MHz | 925 to 960 MHz | 0 to 124 and |
| | | | 975 to 1023 |
| R-GSM 900 | 876 to 915 MHz | 921 to 960 MHz | 0 to 124 and |
| | | | 955 to 1023 |
| DCS 1800 | 1710 to 1785 MHz | 1805 to 1880 MHz | 512 to 885 |
| PCS 1900 | 1850 to 1910 MHz | 1930 to 1990 MHz | 512 to 810 |

### Table 1

Accordingly, the UE may consume additional resources (e.g., battery power, processing resources, and network resources) when searching through additional filters. Additionally, the UE and the target base station will experience latency in establishing an RRC connection, which delays completion of the blind handover.

Some techniques and apparatuses described herein enable a source base station (e.g., base station 110a) to provide an indicator of a frequency band with a configuration message associated with a blind handover. As a result, a UE (e.g., UE 120) may conserve resources (e.g., battery power, processing resources, and network resources) by searching through fewer filters than if the UE 120 had not been provided the indicator of the frequency band. Additionally, the UE 120 and a target base station for the handover (e.g., base station 110b) will establish an RRC connection faster, which speeds up completion of the blind handover.

As indicated above, FIG. 3 is provided as an example. Other examples may differ from what is described with respect to FIG. 3.

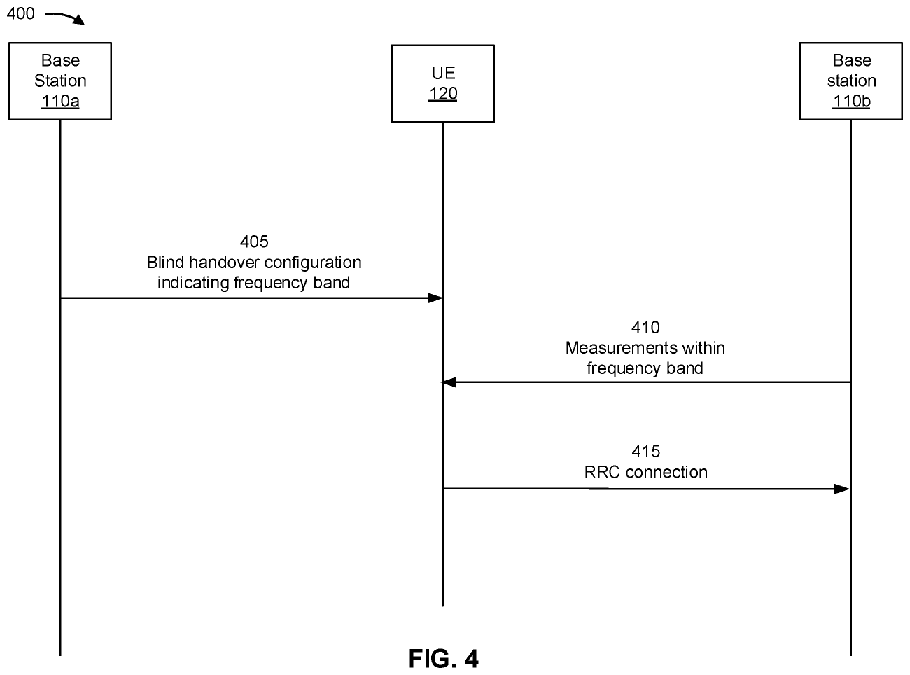

FIG. 4 is a diagram illustrating an example 400 associated with indicating a frequency band during blind handover, in accordance with various aspects of the present disclosure. In example 400, a source base station (e.g., base station 110a) may initiate handover of a UE 120 to a target base station (e.g., base station 110b). In some aspects, the source base station 110a and the target base station 110b may be associated with a same wireless network. For example, the base station 110a may initiate handover of the UE 120 based at least in part on mobility of the UE 120 away from the base station 110a and toward the base station 110b. As an alternative, the base station 110a and the base station 110b may be associated with different wireless networks. For example, the base station 110a may be associated with a legacy network (e.g., an LTE network), and the base station 110b may be associated with an NR network. In another example, the base station 110a may be associated with one NR network, and the base station 110b may be associated with another NR network.

As shown in connection with reference number 405, the base station 110a may transmit, and the UE 120 may receive, a configuration message associated with a blind handover. For example, the configuration message may include an RRC reconfiguration message from the base station 110a to the UE 120. In some aspects, the configuration message may indicate a frequency band for a target cell (e.g., the cell including the base station 110b). For example, the configuration message may include a freqBandIndicatorNR data element (e.g., as defined in 3GPP specifications and/or other standards) and/or another similar data element.

In some aspects, the UE 120 may receive the configuration message from a master node (MN). Accordingly, the base station 110a may comprise an MN on a legacy network (e.g., an LTE network) providing the configuration message for a target cell in an NR network. In one example, the base station 110a may perform handover from the legacy network to the NR network. In another example, the base station 110a may perform secondary cell addition (e.g., adding the base station 110b as a primary secondary cell (PSCell)). Accordingly, the UE 120 may enter a dual connectivity mode (e.g., an Evolved Universal Mobile Telecommunications System Terrestrial Radio Access (E-UTRA) NR-Dual Connectivity (EN-DC) mode) with the base station 110a and the base station 110b. In another example, the base station 110a may perform a secondary node (SN) change (e.g., switching from a different base station in an NR network to the base station 110b as an SN).

In some aspects, the UE 120 may receive the configuration message from a cell within a standalone (SA) NR network. Accordingly, the base station 110a may be included in the cell of the SA NR network. In one example, the base station 110a may perform handover from the cell including the base station 110a to a different cell, in the same SA NR network, including the base station 110b. In another example, the base station 110a may perform handover from SA NR network including the base station 110a to a different SA NR network including the base station 110b. In another example, the base station 110a may perform secondary cell addition (e.g., adding the base station 110b as a PSCell). Accordingly, the UE 120 may enter a dual connectivity mode (e.g., an NR-Dual Connectivity (NR-DC) mode) with the base station 110a and the base station 110b.

In some aspects, the UE 120 may receive the configuration message from an SN. Accordingly, the base station 110a may comprise an SN on an NR network providing the configuration message for a target cell in the same or a different NR network. In one example, the base station 110a may perform secondary cell change (e.g., switching from a different base station to the base station 110b as a PSCell). Accordingly, the UE 120 may enter a dual connectivity mode (e.g., an NR-DC mode or an EN-DC mode) with an MN and the base station 110b. In another example, the base station 110a may perform secondary cell addition (e.g., adding the base station 110b as a new secondary cell (SCell)). Accordingly, the UE 120 may enter a dual connectivity mode (e.g., an NR-DC mode or an EN-DC mode) with an MN and the base station 110b. In another example, the base station 110a may perform an SN change (e.g., switching from the base station 110a to the base station 110b as the SN). Accordingly, the UE 120 may enter a dual connectivity mode (e.g., an NR-DC mode or an EN-DC mode) with an MN and the base station 110b.

In some aspects, the base station 110a may determine that the frequency band for the target cell overlaps with at least one other frequency band. For example, the base station 110a may determine the frequency band for the target cell based at least in part on a backhaul communication, stored information associated with the target cell, and/or previous measurements (e.g., received from other UEs and/or directly measured) from the target cell. Accordingly, the base station 110a may transmit the configuration message that indicates the frequency band for the target cell based at least in part on the determination.

In some aspects, the base station 110a may omit the indicator of the frequency band from the configuration message when the base station 110a may determine that the frequency band for the target cell does not overlap with at least one other frequency band. Accordingly, the base station 110a may dynamically determine whether to include the freqBandIndicatorNR data element (e.g., as defined in 3GPP specifications and/or other standards) and/or another similar data element in the configuration message.

In some aspects, the configuration message may further indicate an ARFCN for the target cell. For example, the configuration message may include an ARFCN-ValueNR data element (e.g., as defined in 3GPP specifications and/or other standards) and/or another similar data element.

Additionally, or alternatively, the configuration message may further indicate at least one of a subcarrier spacing (SCS) or a measurement timing configuration for a synchronization signal from the target cell (e.g., from the base station 110b). For example, the configuration message may include an ssbSubcarrierSpacing data element (e.g., as defined in 3GPP specifications and/or other standards), an smtc1 data element (e.g., as defined in 3GPP specifications and/or other standards), an smtc2 data element, and/or other similar data elements.

As shown in connection with reference number 410, the UE 120 may measure a synchronization signal, from the target cell, based at least in part on the configuration message. For example, the UE 120 may measure an SSB and/or another synchronization signal. In some aspects, as described above, the UE 120 may further use an SCS and/or a measurement timing configuration, indicated by the configuration message, to measure the synchronization signal.

In some aspects, the UE 120 may apply a receive filter, based at least in part on the frequency band, to measure the synchronization signal. For example, the UE 120 may adjust one or more antennas, modulators, and/or other hardware components to apply the reception filter.

As shown in connection with reference number 415, the UE 120 may establish an RRC connection with the base station 110b. For example, the UE 120 may measure the synchronization signal and decode the same in order to establish the RRC connection.

By using the technique described in connection with FIG. 4, the base station 110a may provide the indicator of the frequency band during the blind handover. As a result, the UE 120 may conserve resources (e.g., battery power, processing resources, and network resources) by searching through fewer filters than if the UE 120 had not been provided the indicator of the frequency band. Additionally, the UE 120 and the base station 110b will establish an RRC connection faster, which speeds up completion of the blind handover.

As indicated above, FIG. 4 is provided as an example. Other examples may differ from what is described with respect to FIG. 4.

FIG. 5 is a diagram illustrating an example process 500 performed, for example, by the UE, in accordance with various aspects of the present disclosure. Example process 500 is an example where the UE (e.g., UE 120 and/or apparatus 700 of FIG. 7) performs operations associated with techniques for indicating a frequency band during blind handover.

As shown in FIG. 5, in some aspects, process 500 may include receiving a configuration message associated with a blind handover (block 510). For example, the UE (e.g., using reception component 702, depicted in FIG. 7) may receive the configuration message associated with the blind handover, as described above. In some aspects, the configuration message indicates a frequency band for a target cell.

As further shown in FIG. 5, in some aspects, process 500 may include measuring a synchronization signal, from the target cell, based at least in part on the configuration message (block 520). For example, the UE (e.g., using measurement component 708, depicted in FIG. 7) may measure the synchronization signal, from the target cell, based at least in part on the configuration message, as described above.

Process 500 may include additional aspects, such as any single aspect or any combination of aspects described below and/or in connection with one or more other processes described elsewhere herein.

In a first aspect, the configuration message further indicates an ARFCN for the target cell.

In a second aspect, alone or in combination with the first aspect, the configuration message includes an RRC reconfiguration message.

In a third aspect, alone or in combination with one or more of the first and second aspects, the synchronization signal includes an SSB.

In a fourth aspect, alone or in combination with one or more of the first through third aspects, the configuration message further indicates at least one of an SCS or a measurement timing configuration for the synchronization signal.

In a fifth aspect, alone or in combination with one or more of the first through fourth aspects, the configuration message is received from an MN.

In a sixth aspect, alone or in combination with one or more of the first through fifth aspects, the target cell is within an NR network, and the MN is within a legacy network.

In a seventh aspect, alone or in combination with one or more of the first through sixth aspects, the configuration message is received from an SN.

In an eighth aspect, alone or in combination with one or more of the first through seventh aspects, the SN is within an NR network, and the target cell is an SCell.

In a ninth aspect, alone or in combination with one or more of the first through eighth aspects, the configuration message is received from a cell within an SA NR network.

In a tenth aspect, alone or in combination with one or more of the first through ninth aspects, the target cell is within a different NR network.

In an eleventh aspect, alone or in combination with one or more of the first through tenth aspects, the target cell is an SCell.

In a twelfth aspect, alone or in combination with one or more of the first through eleventh aspects, measuring the synchronization signal comprises applying a receive filter, based at least in part on the frequency band, to measure the synchronization signal.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with various aspects of the present disclosure. Example process 600 is an example where the base station (e.g., base station 110 and/or apparatus 800 of FIG. 8) performs operations associated with techniques for indicating a frequency band during blind handover.

As shown in FIG. 6, in some aspects, process 600 may include determining that a frequency band for a target cell overlaps with at least one other frequency band (block 610). For example, the base station (e.g., using determination component 808, depicted in FIG. 8) may determine that the frequency band for the target cell overlaps with at least one other frequency band, as described above.

As further shown in FIG. 6, in some aspects, process 600 may include transmitting, to a UE (e.g., UE 120 and/or apparatus 700 of FIG. 7) and based at least in part on the determination, a configuration message associated with a blind handover (block 620). For example, the base station (e.g., using transmission component 804, depicted in FIG. 8) may transmit, to the UE and based at least in part on the determination, a configuration message associated with a blind handover, as described above. In some aspects, the configuration message indicates the frequency band for the target cell.

Process 600 may include additional aspects, such as any single aspect or any combination of aspects described below and/or in connection with one or more other processes described elsewhere herein.

In a first aspect, the configuration message further indicates an ARFCN for the target cell.

In a second aspect, alone or in combination with the first aspect, the configuration message includes an RRC reconfiguration message.

In a third aspect, alone or in combination with one or more of the first and second aspects, the configuration message triggers the UE to measure a synchronization signal.

In a fourth aspect, alone or in combination with one or more of the first through third aspects, the synchronization signal includes an SSB.

In a fifth aspect, alone or in combination with one or more of the first through fourth aspects, the configuration message further indicates at least one of an SCS or a measurement timing configuration for the synchronization signal.

In a sixth aspect, alone or in combination with one or more of the first through fifth aspects, the base station is an MN.

In a seventh aspect, alone or in combination with one or more of the first through sixth aspects, the target cell is within an NR network, and the MN is within a legacy network.

In an eighth aspect, alone or in combination with one or more of the first through seventh aspects, the base station is an SN.

In a ninth aspect, alone or in combination with one or more of the first through eighth aspects, the SN is within an NR network, and the target cell is an SCell.

In a tenth aspect, alone or in combination with one or more of the first through ninth aspects, the base station is included in a cell within an SA NR network.

In an eleventh aspect, alone or in combination with one or more of the first through tenth aspects, the target cell is within a different NR network.

In a twelfth aspect, alone or in combination with one or more of the first through eleventh aspects, the target cell is an SCell.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a measurement component 708, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be collocated with the reception component 702 in a transceiver.

In some aspects, the reception component 702 may receive (e.g., from the apparatus 706) a configuration message associated with a blind handover. The configuration message may indicate a frequency band for a target cell. Accordingly, the measurement component 708 may measure a synchronization signal, from the target cell, based at least in part on the configuration message. In some aspects, the measurement component 708 may include one or more antennas, a demodulator, a MIMO detector, a receive processor, a controller/processor, a memory, or a combination thereof, of the UE described above in connection with FIG. 2. In some aspects, the transmission component 704 may establish an RRC connection with the target cell, based at least in part on the measurement component 708 measuring the synchronization signal.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a block diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a determination component 808, among other examples.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the base station described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the base station described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the base station described above in connection with FIG. 2. In some aspects, the transmission component 804 may be collocated with the reception component 802 in a transceiver.

In some aspects, the determination component 808 may determine that a frequency band for a target cell overlaps with at least one other frequency band. In some aspects, the determination component 808 may include a receive processor, a transmit processor, a controller/processor, a memory, or a combination thereof, of the base station described above in connection with FIG. 2. In some aspects, the reception component 802 may receive, from the target cell and/or one or more UEs, an indication of the frequency band for the target cell. Accordingly, the transmission component 804 may transmit, to the apparatus 806 and based at least in part on the determination, a configuration message associated with a blind handover. The configuration message may indicate the frequency band for the target cell.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving a configuration message associated with a blind handover, that indicates a frequency band for a target cell; and
measuring a synchronization signal, from the target cell, based at least in part on the configuration message.

2. The method of claim 1, wherein the configuration message further indicates an absolute radio-frequency channel number (ARFCN) for the target cell.

3. The method of claim 1, wherein the configuration message includes a radio resource control (RRC) reconfiguration message.

4. The method of claim 1, wherein the synchronization signal includes a synchronization signal block (SSB).

5. The method of claim 1, wherein the configuration message further indicates at least one of a subcarrier spacing (SCS) for the synchronization signal or a measurement timing configuration for the synchronization signal.

6. The method of claim 1, wherein the configuration message is received from a master node.

7. The method of claim 6, wherein the synchronization signal is measured from the target cell within a New Radio (NR) network, and the configuration message is received from the master node within a legacy network.

8. The method of claim 1, wherein the configuration message is received from a secondary node.

9. The method of claim 8, wherein the configuration message is received from the secondary node within a New Radio (NR) network, and the target cell is a secondary cell.

10. The method of claim 1, wherein the configuration message is received from a cell within a standalone (SA) New Radio (NR) network.

11. The method of claim 10, wherein the target cell is within a different NR network.

12. The method of claim 10, wherein the target cell is a secondary cell.

13. The method of claim 1, wherein measuring the synchronization signal comprises applying a receive filter, based at least in part on the frequency band, to measure the synchronization signal.

14. A method of wireless communication performed by a network node, comprising:
determining that a frequency band for a target cell overlaps with at least one other frequency band; and
transmitting, based at least in part on the determination, a configuration message, associated with a blind handover, that indicates the frequency band for the target cell.

15. The method of claim 14, wherein the configuration message further indicates an absolute radio-frequency channel number (ARFCN) for the target cell.

16. The method of claim 14, wherein the configuration message includes a radio resource control (RRC) reconfiguration message.

17. The method of claim 14, wherein the configuration message triggers a user equipment (UE) to measure a synchronization signal.

18. The method of claim 17, wherein the synchronization signal includes a synchronization signal block (SSB).

19. The method of claim 17, wherein the configuration message further indicates at least one of a subcarrier spacing (SCS) for the synchronization signal or a measurement timing configuration for the synchronization signal.

20. The method of claim 14, wherein the network node is a master node.

21. The method of claim 20, wherein the configuration message indicates the frequency band for the target cell within a New Radio (NR) network, and the master node is within a legacy network.

22. The method of claim 14, wherein the network node is a secondary node.

23. The method of claim 22, wherein the secondary node is within a New Radio (NR) network, and the configuration message indicates the frequency band for the target cell that is a secondary cell.

24. The method of claim 14, wherein the network node is included in a cell within a standalone (SA) New Radio (NR) network.

25. The method of claim 24, wherein the target cell is within a different NR network.

26. The method of claim 24, wherein the target cell is a secondary cell.

27. An apparatus for wireless communication at a user equipment (UE), comprising:
a memory; and
one or more processors coupled to the memory, the one or more processors configured to:
receive a configuration message, associated with a blind handover, that indicates a frequency band for a target cell; and
measure a synchronization signal, from the target cell, based at least in part on the configuration message.

28. The apparatus of claim 27, wherein the configuration message further indicates an absolute radio-frequency channel number (ARFCN) for the target cell.

29. The apparatus of claim 27, wherein the configuration message includes a radio resource control (RRC) reconfiguration message.

30. The apparatus of claim 27, wherein the synchronization signal includes a synchronization signal block (SSB).

31. The apparatus of claim 27, wherein the configuration message further indicates at least one of a subcarrier spacing (SCS) for the synchronization signal or a measurement timing configuration for the synchronization signal.

32-38. (canceled)

39. The apparatus of claim 27, wherein the one or more processors, to measure the synchronization signal, are configured to apply a receive filter, based at least in part on the frequency band, to measure the synchronization signal.

40. An apparatus for wireless communication at a network node, comprising:
a memory; and
one or more processors coupled to the memory, the one or more processors configured to:
determine that a frequency band for a target cell overlaps with at least one other frequency band; and
transmit, based at least in part on the determination, a configuration message, associated with a blind handover, that indicates the frequency band for the target cell.

41. The apparatus of claim 40, wherein the configuration message further indicates at least one of an absolute radio-frequency channel number (ARFCN) for the target cell, a subcarrier spacing (SCS) for a synchronization signal, or a measurement timing configuration for the synchronization signal.

42-52. (canceled)

53. A non-transitory computer-readable medium storing a set of instructions for wireless communication, the set of instructions comprising:
one or more instructions that, when executed by one or more processors of a user equipment (UE), cause the UE to:
receive a configuration message, associated with a blind handover, that indicates a frequency band for a target cell; and
measure a synchronization signal, from the target cell, based at least in part on the configuration message.

54-104. (canceled)
